(19) United States
(12) Patent Application Publication
(10) Pub. No.: US 2006/0163996 A1
(43) Pub. Date: Jul. 27, 2006

(54) Field emitters and devices

(76) Inventors: Richard Allan Tuck, Slough (GB); Michael Stuart Waite, Altrincham (GB); Christopher Howard, Oxford (GB)

Correspondence Address: BARNES & THORNBURG, LLP, P.O. BOX 2786, CHICAGO, IL, 60690-2786, US

(21) Appl. No.: 10/559,094

(22) PCT Filed: May 14, 2004
(86) PCT No.: PCT/EP04/50809

§ 371 Date: Mar. 23, 2006

(30) Foreign Application Priority Data
May 16, 2003 (GB) 0311296.8

(51) Int. Cl. H01J 9/02; H01J 1/14

(52) U.S. Cl. 313/310; 313/311

(57) ABSTRACT

A broad area field electron emitter comprises a plurality of emitter cells of layered structure. Each cell comprises a hole having a layer of field electron emission material 501 at its base. A gate electrode 503 is spaced from the emitter layer 501 by a dielectric material 502 having a first region in contact with the emitter layer 501 and a second region in contact with the gate electrode 503. The cell diameter is greater at the level of the gate 503 than at the level of the emitter layer 501, thus enabling electrons in electron beam 505 and emitted from sites adjacent to the side walls of the cell to avoid interception by the gate 503 at point 506. This reduces cell-wall charge between the first and second regions of dielectric material 502, and other means for achieving this are disclosed.

This invention relates to field emission materials and devices, and is concerned particularly but not exclusively with methods of manufacturing addressable field electron emission cathode arrays. Preferred embodiments of the present invention aim to provide improved designs for multi-electrode control and focusing structures.

It has become clear to those skilled in the art that the key to practical field emission devices, particularly displays, lies in arrangements that permit the control of the emitted current with low voltages. Until recently, the majority of the art in this field related to tip-based emitters—that is, structures that utilise atomically sharp micro-tips as the field emitting source.

There is considerable prior art relating to tip-based emitters. The main objective of workers in that art has been to place an electrode with an aperture (the gate) less than 1 micron away from each single emitting tip, so that the required high fields can by achieved using applied potentials of 100V or less—these emitters are termed gated arrays. The first practical realisation of this was described by C A Spindt, working at Stanford Research Institute in California (J. Appl. Phys. 39,7, pp3504-3505, (1968)). Spindt's arrays used molybdenum emitting tips which were produced, using a self masking technique, by vacuum evaporation of metal into cylindrical depressions in a SiO₂ layer on a Si substrate. Many variants and improvements on the basic Spindt technology are described in the scientific and patent literature.

In about 1985, it was discovered that thin films of diamond could be grown on heated substrates from a hydrogen-methane atmosphere, to provide broad-area field emitters.

In 1988, S Bajic and R V Latham (Journal of Physics D Applied Physics, vol. 21 200-204 (1988)), described a low-cost composite that created a high density of metal-insulator-metal-insulator-vacuum (MIMIV) emitting sites. The composite had conducting particles dispersed in an epoxy resin. The coating was applied to the surface by standard spin coating techniques.

Much later (1995) Tuck, Taylor and Latham (GB 2 304 989) improved the above MIMIV emitter by replacing the epoxy resin with an inorganic insulator that both improved stability and enabled it to be operated in sealed off vacuum devices.

Work in this area, which includes carbon and other nanotube layers, is now very fashionable and there is a building body of art in both the patent and scientific literature.

The best examples of such broad-area emitters can produce usable electric currents at fields less than 10 V/micron. In the context of this specification, a broad-area field emitter is any material including carbon and other nanotube layers that by virtue of its composition, micro-structure, work function or other property emits useable electronic currents at macroscopic electrical fields that might be reasonably generated at a planar or near-planar surface—that is, without the use of atomically sharp micro-tips as emitting sites.

Electron optical analysis shows that the feature size required to control a broad-area emitter is nearly an order of magnitude larger than for a tip-based system. Zhu et al (U.S. Pat. No. 5,283,501) describes such structures with diamond-based emitters. Moyer (U.S. Pat. No. 5,473,218) claims an electron optical improvement in which a conducting layer sits upon the broad-area emitter to both prevent emission into the gate insulator and focus electrons through the gate aperture. The concept of such structures was not new and is electronoptically equivalent to arrangements that had been used in thermionic devices for many decades. For example Winsor (U.S. Pat. No. 3,500,110) described a shadow grid at cathode potential to prevent unwanted electrons intercepting a grid set at a potential positive with respect to the cathode. Somewhat later, Miram (U.S. Pat. No. 4,096,406) improved upon this to produce a bonded grid structure in which the shadow grid and control grid are separated by a solid insulator and placed in contact with the cathode. Moyer's arrangement simply replaced the thermionic cathode in Miram's structure with an equivalent broad-area field emitter. However, such structures are useful, with the major challenge being methods of constructing them at low cost and over large areas. However, to perform strong focusing, the conducting layer in Moyer's structure really needs to be rather thick—such a structure has been described by Macaulay et al (U.S. Pat. No. 5,552,659).

It is in the area of emitter cell design, particularly for field emitting displays and permitting stable operation, that preferred embodiments of the present invention make a contribution to the art.

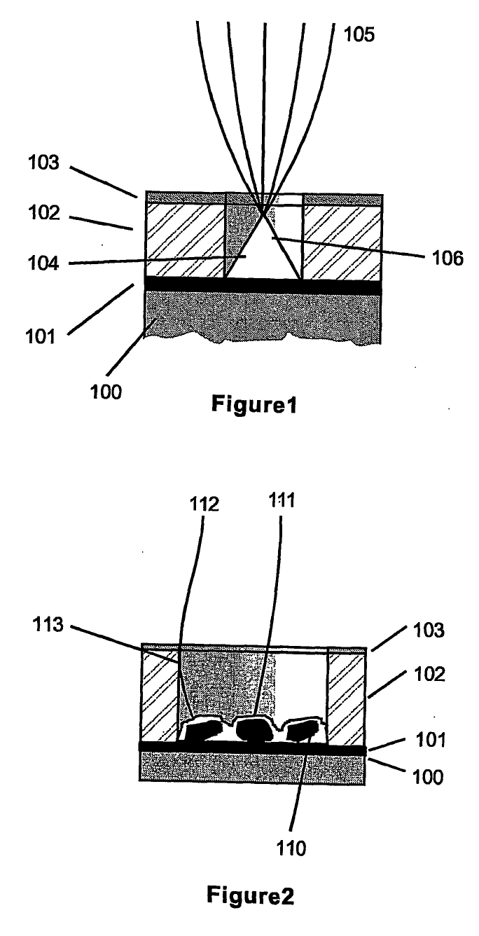

FIG. 1 illustrates the geometry of a gate-controlled emitter cell typical of the prior microtip-based art. Note that in this drawing and all subsequent similar illustrations, there is a remote positively biased anode at a distance of typically 0.1 mm to 3 mm above the cathode plane. An insulating substrate (often glass) 100 has a cathode address track 101, a gate insulator 102 (often silica) and a gate electrode 103. The diameter of the via in which the microtip is located is in the range of a few microns down to 0.1 micron. A microtip emitter is formed within this cell by a variety of processes, with the Spindt process (J. Appl. Phys. 39,7, pp3504-3505, (1968)) being by far the most common. A feature of such designs is that the emitting point 106 of the microtip 104 sits high in the structure, such that the divergent beam of emitted electrons 105 passes easily without interception by the gate or gate insulator walls into the cathode-anode space.

Devices based upon broad-area emitters offer many advantages over the previous tip-based art. In particular, the ideal size for the emitter cell is now ˜10 microns in diameter, facilitating considerable reductions in the cost of fabrication compared to the semiconductor-type processes used to make tip-based structures.

However, practical experience with such broad-area-based devices shows that, on close inspection, the operation of the emitter cells can be unstable, with cathode-gate micro-discharges that can eject plasma and trigger destructive cathode (or gate) to anode arcs.

FIG. 2 illustrates the problem. In the case of microtip emitters, the emitting site is located both on axis and high in the cell, whereas (FIG. 2) the emitting sites 110 formed from emitting materials such as those described by the applicants (GB 2 304 989) sit low in the cell and are randomly located. Moreover, the region of highest electrical field is around the perimeter of the cell, favouring emitting paths 112 near the cells walls over well centred ones 111.

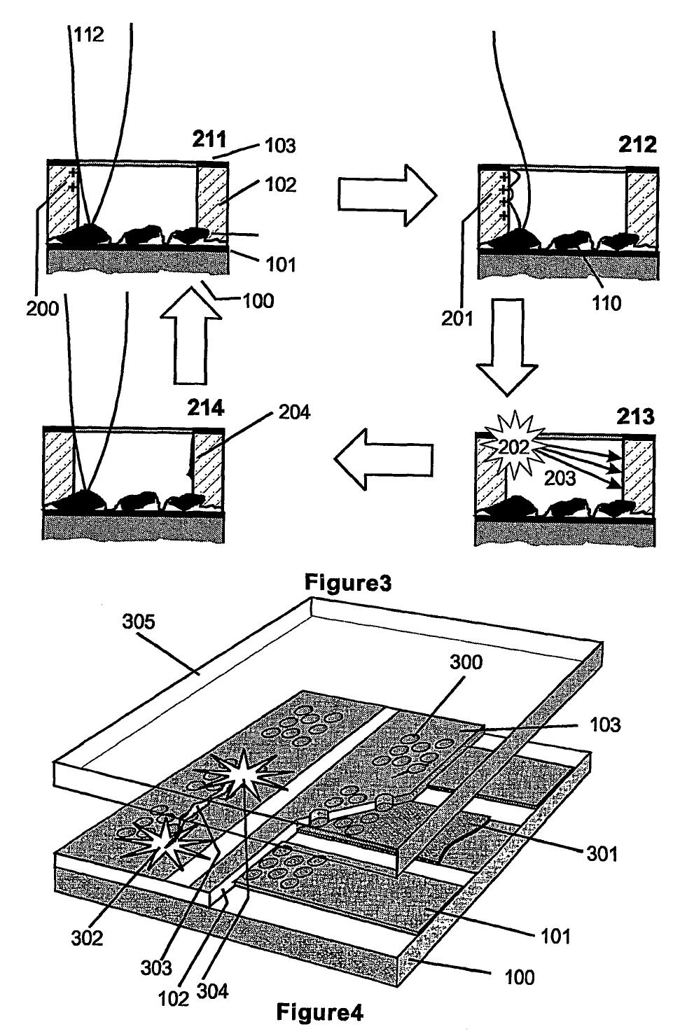

The applicants have discovered that the primary process that causes this instability is as illustrated in FIG. 3. The process is believed to be a cyclical relaxation process involving charging and discharging of the cell walls. The cycle starts at 211, where electrons 112 are intercepted by the cell wall. If the energy of the electron beam is such that the secondary emission coefficient is greater than unity (a likely situation for silica-based gate insulators), then more electrons will leave than arrive, leading to a net positive charge on the cell wall 200. In 212, this positive charging has increased, with the result that emitted electrons are attracted towards the cell walls which, in turn, leads to more charging 201. In 213 the fields generated by the charging are sufficient that a surface breakdown 202 occurs. The breakdown dissipates the surface charge but, at the same time, can eject plasma into the cathode-anode space and evaporate metal from the gate 203 onto the insulator surface, leading to a build up of conducting material 204 as illustrated in 214. This build up of conducting material 204 can eventually degrade the cathode-gate insulation to a point where the device can no longer be driven by the electronics.

FIG. 4 illustrates the situation that occurs if sufficient plasma is injected into the cathode-anode space to trigger an arc. The ejected plasma 302 triggers an arc 303, which leads to local heating on the anode 304. Such local heating can damage the phosphor layer on the anode of a display device and evaporate material back onto the cathode, often with deleterious results.

We have discovered also that the sensitivity of display devices to such effects increases with both the number of pixels and the anode voltage. This problem thus represents a major obstruction to the creation of the large-area low-cost display devices that broad-area emitters offer.

Preferred embodiments of the present invention aim to provide improved field emitting structures with emitter cells that can emit electrons in a stable manner.

Such emitter structures may be used in devices that include: field electron emission display panels; light emitting modules for stadium-type displays; high power pulse devices such as electron MASERS and gyrotrons; crossed-field microwave tubes such as CFAs; linear beam tubes such as klystrons; flash x-ray tubes; triggered spark gaps and related devices; broad area x-ray sources for sterilisation; vacuum gauges; ion thrusters for space vehicles; particle accelerators; lamps; ozonisers; and plasma reactors.

According to one aspect of the present invention, there is provided a road area field electron emitter comprising a plurality of emitter cells formed in a layered structure, each cell comprising a hole at the base of which a field electron emission material is disposed:

wherein said layered structure comprises:

an emitter layer having a substrate provided with an electrically conductive surface and said field electron emission material disposed on said surface;

a gate electrode spaced from said emitter layer; and

dielectric material disposed between said emitter layer and said gate electrode:

and wherein:

a first region of dielectric material contacts said emitter layer;

a second region of dielectric material contacts said gate electrode; and

means is provided for reducing cell-wall charge between said first and second regions.

Said means for reducing cell-wall charge may comprise an increase in the diameter of each cell from said first region to said second region.

The side walls of each cell may taper linearly from said first region to said second region.

The side walls of each cell may taper in a curved shape from said first region to said second region. Each cell may thus be bucket shaped or bowl shaped.

Said means for reducing cell-wall charge may comprise a current-leakage path provided by said dielectric material or a further material provided in or on said dielectric material.

Said dielectric material or further material may be selected from the group comprising chromium sesquioxide and silica with low concentrations of carbon or iron oxide.

Said means for reducing cell-wall charge may comprise a low secondary electron yield material with first cross-over potential less than the maximum emitter layer to gate voltage of the emitter, said low secondary electron yield material comprising said dielectric material or an insulator material provided on the side walls of each cell.

Said dielectric material or further material may be selected from the group comprising Cr₂O₃, SiN, a-Si SiC, carbon and implanted carbon.

Said means for reducing cell-wall charge may comprise a layered configuration within said dielectric material, to provide focusing of electrons emitted by said field electron emission material.

Said layered configuration may comprise a thin focus electrode between layers of said dielectric material.

Said thin focus electrode is of metal—for example, chromium.

Said thin focus electrode preferably has a thickness of less than 1 micron—for example, in the range of approximately 0.1 to 0.2 microns.

Said layered configuration may comprise layers of dielectric material of differing dielectric constant.

Said layers of dielectric material of differing dielectric constant may comprise a layer of lower dielectric constant which has a thickness in the range 10% to 80%, of the thickness of the layered configuration of said dielectric material.

Said layers of dielectric material may have dielectric constants that differ in a ratio of at least 3:2.

Said layers of dielectric material may have dielectric constants that differ in a ratio of at least 4:1.

Said dielectric material may include a layer of material that is porous relative to the rest of the dielectric material, to trap electrons.

Said porous material may have a porosity of approximately 50%.

In another aspect, the invention provides a field electron emission device comprising a broad area field electron emitter according to any of the preceding claims, and means for subjecting said emitter to an electric field in order to cause said emitter to emit electrons.

Such a device may comprise a substrate with an array of patches of said broad area field electron emitter.

A device as above may comprise a plasma reactor, corona discharge device, silent discharge device, ozoniser, an electron source, electron gun, electron device, x-ray tube, vacuum gauge, gas filled device or ion thruster.

The broad area field electron emitter may supply the total current for operation of the device.

The broad area field electron emitter may supply a starting, triggering or priming current for the device.

A device as above may comprise a display device.

A device as above may comprise a lamp.

Said lamp may be substantially flat.

Said broad area field electron emitter may be connected to an electric driving means via a ballast resistor to limit current.

Said ballast resistor may be applied as a resistive pad under each said emitting patch or in the form of a laterally conducting layer to segments of the emitting region.

Said broad area field electron emitter and/or a phosphor may be coated upon one or more one-dimensional array of conductive tracks which are arranged to be addressed by electronic driving means so as to produce a scanning illuminated line.

Such a device may include said electronic driving means.

Said broad area field electron emitter may be disposed in an environment which is gaseous, liquid, solid, or a vacuum.

A device as above may comprise a cathode which is optically translucent and is so arranged in relation to an anode that electrons emitted from the cathode impinge upon the anode to cause electro-luminescence at the anode, which electro-luminescence is visible through the optically translucent cathode.

For a better understanding of the invention, and to show how embodiments of the same may be carried into effect, reference will now be made, by way of example, to the accompanying diagrammatic drawings.

FIG. 1 shows the construction of a typical microtip emitter cell;

FIG. 2 shows the construction of a typical broad-area emitter cell;

FIG. 3 illustrates a cyclical wall charging process within emitter cells;

FIG. 4 illustrates how cell breakdown can lead to cathode-anode arcs;

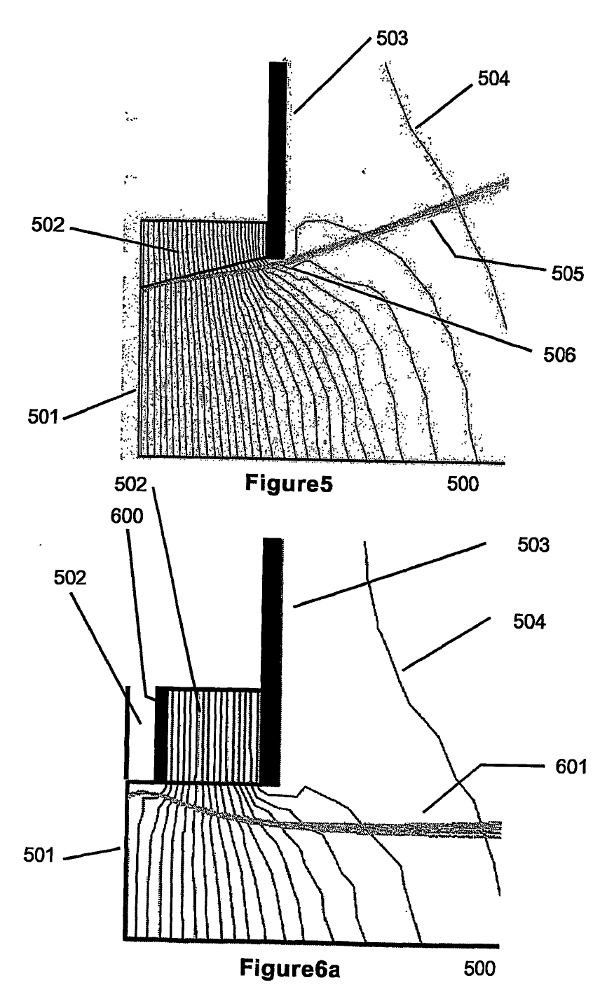

FIG. 5 shows a cell design with sloping sidewalls to avoid electron interception, with modelled electron trajectories;

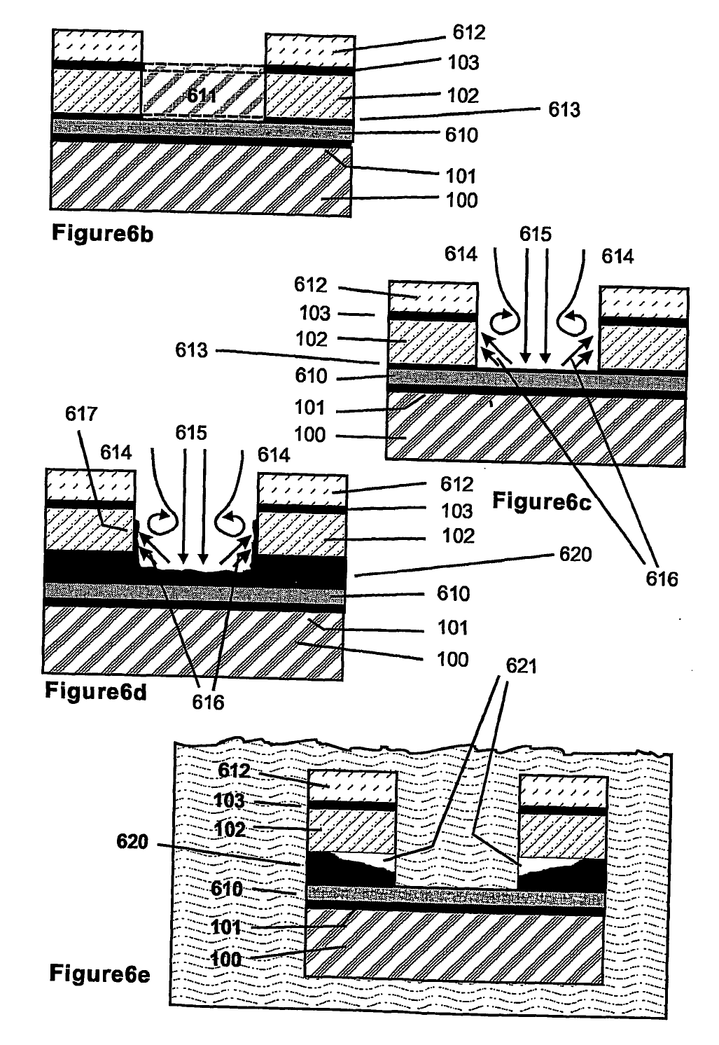

FIG. 6a shows a cell design with an additional electrode that focuses electrons away from the cell walls, with modelled electron trajectories;

FIGS. 6a to 6b illustrate difficulties that can be encountered with a thick metallic layer;

FIG. 7 shows a cell design with an intermediate porous silica layer, with modelled electron trajectories;

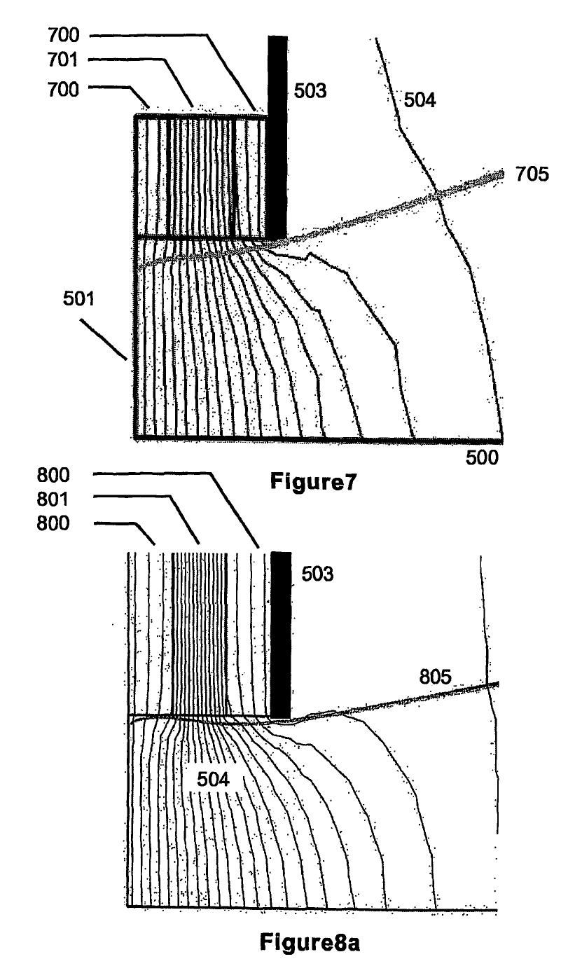

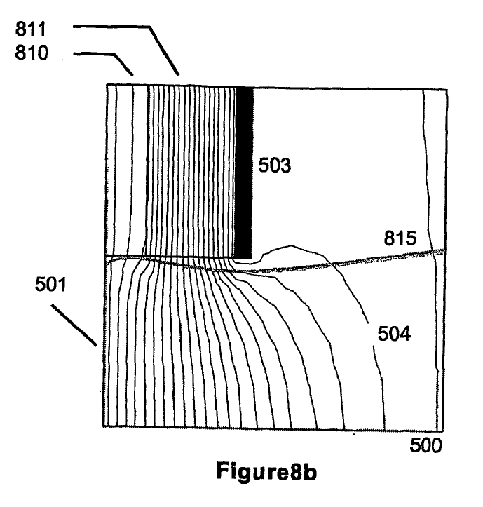

FIG. 8a shows a cell design with an intermediate porous silica layer sandwiched between high dielectric constant layers to focus electrons away from the cell walls, with modelled electron trajectories;

FIG. 8b shows a low capacitance design where a thin layer of high dielectric constant material is covered by a much thicker layer of low dielectric constant material, with modelled electron trajectories;

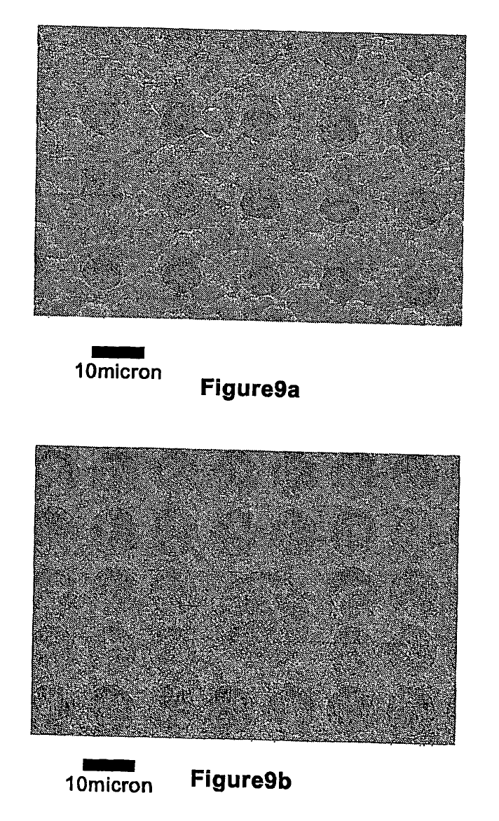

FIG. 9a is a scanning electron micrograph (SEM) to illustrate a problem associated with building gated arrays on textured emitter surfaces;

FIG. 9b is a scanning electron micrograph (SEM) to illustrate use of a printed layer having strong planarising properties;

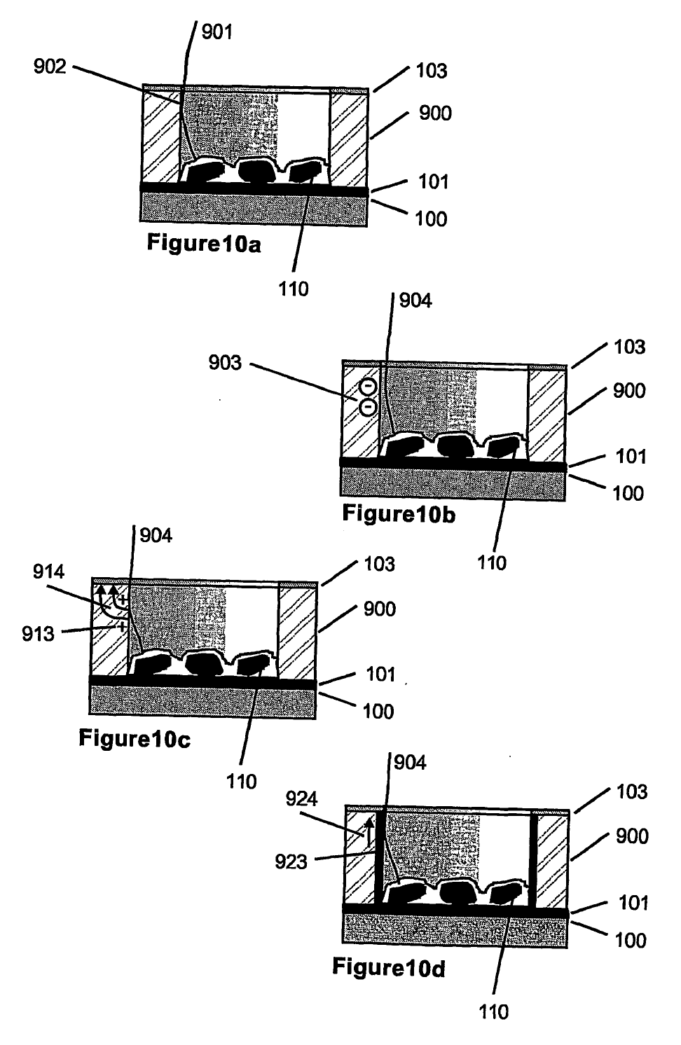

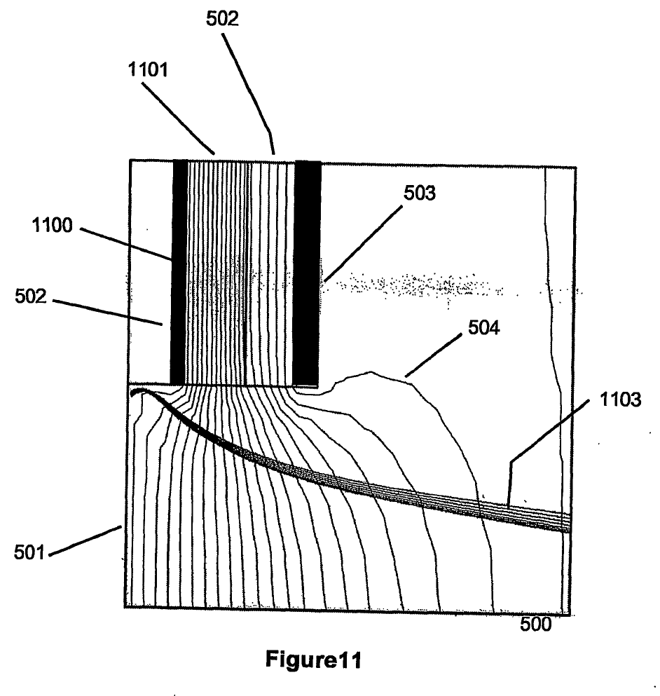

FIGS. 10a to 10d illustrate cell designs utilising low secondary emission and charge leakage;

FIG. 11 shows a cell design combining various different design features, with modelled electron trajectories; and

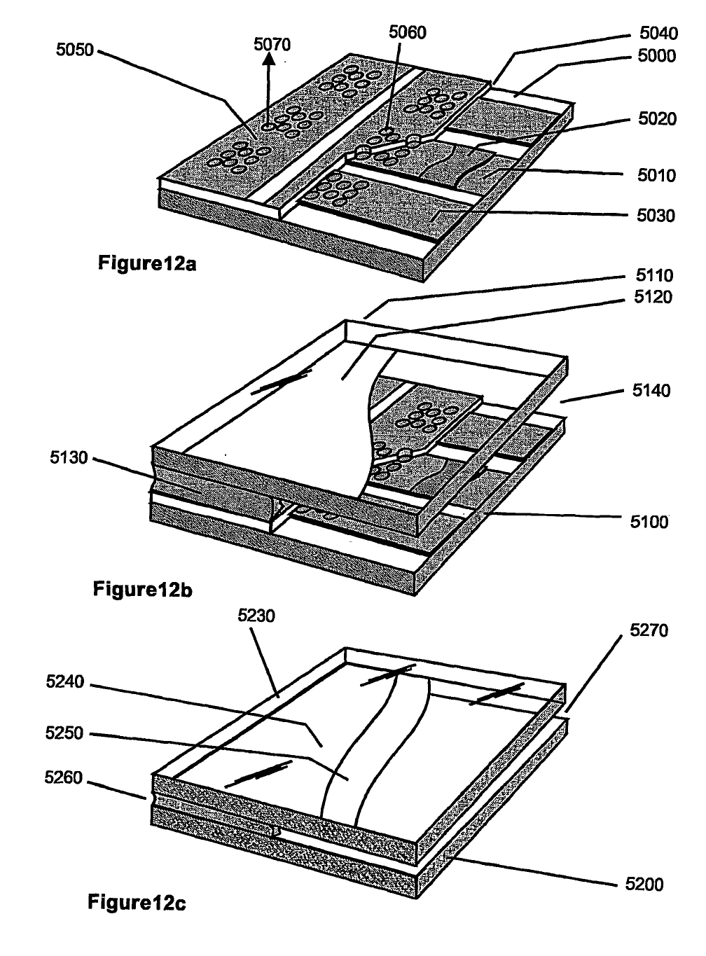

FIGS. 12a to 12c illustrate examples of devices that may use broad area field electron emitter cathodes embodying the invention.

In the figures, like reference denote like or corresponding parts.

FIGS. 1 to 4 have been discussed above.

### EXAMPLE 1

FIG. 5 shows a geometric solution to the problem of sidewall interception. The illustration shows a half cross-section of an emitter cell structure with 500 being an axis of symmetry. The problem has been modelled using a finite element code with electron ray tracing. A broad-area field electron emitter layer 501, gate insulator 502 and gate 503 are shown, together with computed equipotentials 504 and electron beam 505. In this example, the base of the cell is 10 microns in diameter (although other diameters may be chosen) and the diameter of the cell increases linearly to 12 microns at the gate level. Other geometric and dimensional arrangements may be utilised, the significant point being that the diameter is greater at the level of the gate 503 than at the level of the emitter layer 501. Such an arrangement enables electrons emitted from sites adjacent to the sidewall to just avoid interception by the gate 503 at point 506.

Such a structure may be formed by wet photo-etching of the gate insulator 502, followed by removal of the gate metal from below the resist layer or by reactive ion etching using shaped apertures within a resist layer.

The emitter layer 501 comprises a substrate, cathode tracks, emitter material and any remaining etch-stop layer below the gate insulator 502. Etch-stop layers are discussed below, and in the context of this specification, the term “emitter layer” includes any such etch-stop layer that is used to protect the emitter material during processing.

### EXAMPLE 2

Moving now to FIG. 6a, another suitable cell structure is illustrated. In this case, an additional electrode layer 600 is disposed between two layers of dielectric 502. However, the arrangement of FIG. 6 eliminates the need for very thick metal vacuum deposited layers with their associated cost and stress problems. Two particular problems with thick metallic layers in such structures are illustrated in FIGS. 6b to 6e.

FIG. 6b shows a method of fabricating an emitter cell used frequently by the applicants and described in GB 2 330 687. In this method, the various layers of the structure of the gate structure are built up on the emitter layer, which comprises substrate 100, cathode tracks 101, emitter material 610 and etch stop layer 613. A photoresist layer 612 is applied and patterned to define the location and diameter of each cell. A self-aligned process using selective etches is then used to remove the unwanted layers 611. A problem that is found is that the etch system for the gate insulator (often silica) also attacks the emitter material 610, which is often a silica-carbon composite layer. The solution described in the above patent specification is to provide the additional etch stop layer 613 that resists the typically fluorine-based chemistry of the gate insulator etch, but can be removed later without chemical attack of the emitter material.

A thick electrode layer can present some major fabrication difficulties. In the case of a reactive ion etch processes, FIG. 6c shows that, in addition to the desired chemical removal of the etch-stop material that results in volatile species that are swept away by the process gas 614, there is also a physical sputtering effect from ions 615 which deposits non-volatile etch-stop material 616 onto the cell walls. This material then affects the electrical insulation of the cell, and in doing so, affects device performance. With thin sub-micron etch stop layers, this contamination can be controlled. With thick layers 620 of 1 micron or greater, there would be a considerable build-up 617 of sputtered material 616 (FIG. 6d) on cell walls, which has an adverse affect on device performance.

FIG. 6e illustrates the situation if one tries to avoid the above problem by using a wet chemical etch. In this case, an undercut 621 forms that not only affects the electron-optical efficiency of the structure but, by undermining, can also put the structural integrity of the whole device at risk due to delamination of layers.

Returning now to the example of FIG. 6a, both insulating layers 502 may be deposited by a low cost printing process using, for example, inks as described by the applicants in their co-pending application (GB 02 22360.0).

The focusing electrode 600 is usually held at cathode potential, although other potentials may be used to adjust the focusing effect. Finite element modelling shows that the electric field from the gate potential penetrates to only a small degree between electrodes 501 and 600 which, if at the same potential, act for all practical purposes as a single electrode. The structure exhibits strong focusing and keeps the emitted electrons 601 well away from the sidewall of the cell, thus avoid the previously described charging effects.

### EXAMPLE 3

Moving now to FIG. 7, a cell structure has a porous silica layer 701 sandwiched between two fully dense silica layers 700. Layer 701 may be deposited by screen printing, using inks as described by the applicants in their co-pending application (GB 0222360.0). Layers 700 may be deposited by a range of techniques, including plasma-enhanced chemical vapour deposition (PECVD) and sputter coating.

The scanning electron micrograph (SEM) in FIG. 9a illustrates a problem associated with building gated arrays on textured emitter surfaces such as those described by the applicants in GB 2 304 989 and related specifications. When using techniques such as PECVD or sputter coating for the gate insulator deposition, the texture of the emitter surface nucleates film growth, resulting in a smoothed but hillocky morphology. This makes etching of the emitter cell vias difficult to control and produces distorted field patterns around the apertures in the gate electrode, which can direct electrons in undesirable directions.

The printed layer 701 in FIG. 7 has strong planarising properties, as shown by the SEM image of a device using such a layer in FIG. 9b. Note that the large via is for inspection purposes.

The applicants have observed that structures as described above have a much reduced incidence of cell wall charging and associate cathode-gate and cathode-anode discharges. This results in devices that can sustain increased anode voltages, leading to brighter longer lived displays.

The applicants believe that such improvements may result from a combination of factors:
1. The lower dielectric constant of the porous silica 701 (k=2) compared to fully dense silica layers 700 (k=3.9) form a weak electrostatic lens, providing some focusing of electron beam 705 away from the cell walls.
2. The porous nature of the layer 701 traps electrons, thereby reducing the secondary emission coefficient and hence the tendency of the surface to charge positive.
3. The rough nature of the surface of the layer 701 increases the tracking distance along the cell wall and so improves the voltage hold-off.
4. The multi-layer structure reduces the chances of anomalously large features on the emitter layer bridging between cathode and gate and producing potential areas for breakdown either inside or outside the cell structures.

### EXAMPLE 4

Inspection of the electron ray tracing in FIG. 7 shows that the focusing effect of the lens so formed is insufficient to prevent electrons emitted very close to the cell walls from being intercepted. FIG. 8a shows a structure where the same porous silica 801 is sandwiched between two layers of much higher dielectric constant (e.g. TiO₂). In the case modelled, a printed porous TiO₂ (k=7) is assumed. Note the much stronger focusing action on the electrons 805 than those 705 in Example 3. Benefits 1 to 4 above will also apply to this arrangement.

### EXAMPLE 4a

A disadvantage of using high dielectric constant materials is that they increase the parasitic capacitance between cathode and gate, the charging and discharging of which at video rates accounts for a large proportion of the power consumption of a field emission display. One would thus wish to use the very minimum amount of such materials. FIG. 8b shows a low capacitance design where a thin layer of high dielectric constant material 810 is covered by a much thicker layer of low dielectric constant material 811 upon which is the gate electrode 503.

Such a structure provides good focusing 815 and low capacitance.

### EXAMPLE 5

Examples 1 and 2 have concentrated on directing emitted electrons away from the emitter cell walls. Examples 3 and 4 combine this with some control of the electrical properties of the cell walls. An alternative approach is to accept cell wall interception and modify the surface and/or bulk electrical properties of the gate insulator material 900 (FIG. 10) to either keep the secondary emission coefficient below unity at the maximum cathode to gate voltage and/or provide sufficient controlled electrical leakage to enable any build up of charge to leak away.

FIG. 10a shows the effect of such structures where the electron beam 901 incepts the cell wall 902 but, in this case (FIG. 10b), the wall charges negatively 903 repelling further electron impacts and diverting the beam 904.

An alternative or complementary approach is introduce controlled electrical leakage. FIG. 10c shows a situation where the gate insulator material 900 exhibits sufficient electrical leakage to prevent charges 913 building up to dangerous levels by enabling electrons 914 to leak away to the gate electrode 103.

A suitable material would be a printed layer based upon chromium sesquioxide (Cr₂O₃) which has both desirable secondary emission and electrical leakage properties.

Equally, FIG. 10d) the walls could be coated at 923 with such materials as Cr₂O₃, SiN, a-Si, SiC or carbon to control secondary emission and/or provide leakage paths 924 to enable charge to bleed away.

### EXAMPLE 6

The various approaches described in these examples—cell shaping, focusing electrodes, dielectric lenses, low secondary emission and electrically leaky structures—may be combined with each other to gain best effect. FIG. 11 shows but one example of many possible combinations, wherein a thin focus electrode 1100 at cathode potential is combined with a layer of porous low dielectric constant material 1101. This particular arrangement not only results in even stronger deflection of electrons that would otherwise intercept the cell walls 1103, but also provides planarisation of the gate layer as illustrated in FIG. 9b.

The above-described an illustrated emitter cell structures may be used in devices that include: field electron emission display panels; light-emitting modules for stadium-type displays; high power pulse devices such as electron MASERS and gyrotrons; crossed-field microwave tubes such as CFAs; linear beam tubes such as klystrons; flash x-ray tubes; triggered spark gaps and related devices; broad area x-ray sources for sterilisation; vacuum gauges; ion thrusters for space vehicles; particle accelerators; lamps; ozonisers; and plasma reactors.

Examples of some of these devices are illustrated in FIGS. 12a, 12b and 12c. For simplicity, simple emitter cells are illustrated but in each case, one of the more sophisticated cell designs described herein may be substituted.

FIG. 12a shows an addressable gated cathode as might be used in a field emission display. The structure comprises an emitter layer formed of an insulating substrate 5000, cathode tracks 5010, emitter material 5020 and etch stop layer 5030 electrically connected to the cathode tracks. A gate insulator 5040 and gate tracks 5050 are disposed over the emitter layer. The gate tracks and gate insulators are perforated with emitter cells 5060. A negative bias on a selected cathode track and an associated positive bias on a gate track causes electrons 5070 to be emitted towards an anode (not shown).

The reader is directed to our patent GB 2 330 687 for further details of constructing Field Effect Devices.

The electrode tracks in each layer may be merged to form a controllable but non-addressable electron source that would find application in numerous devices.

FIG. 12b shows how the addressable structure in FIG. 12a described above may be joined with a glass fritt seal 5130 to a transparent anode plate 5110 having upon it a phosphor screen 5120. The space 5140 between the plates is evacuated, to form a vacuum display device.

Although a monochrome display has been described, for ease of illustration and explanation, it will be readily understood by those skilled in the art that a corresponding arrangement with a three-part pixel may be used to produce a colour display.

FIG. 12c shows a flat lamp using one of the above-described materials. Such a lamp may be used to provide backlighting for liquid crystal displays, although this does not preclude other uses, such as room lighting.

The lamp comprises a cathode plate 5200 comprising a version of that in FIG. 12a, where the rows and columns are separately merged into a broad-area device. Ballast layers as described in our patent GB 2 304 989 may be used to improve the uniformity of emission. A transparent anode plate 5230 has upon it a conducting layer 5240 and a phosphor layer 5250. A ring of glass fritt 5260 seals and spaces the two plates. The interspace 5270 is evacuated.

The operation and construction of such devices, which are only examples of the many applications of preferred embodiments of this invention, will readily be apparent to those skilled in the art. An important feature of preferred embodiments of the invention is the ability to use broad-area emitters and printed or directly photo-patternable layers where appropriate, thus enabling complex multi-emitter structures, such as those required for displays, to be created at modest cost. In the context of this specification, printing means a process that places or forms an emitting material in a defined pattern. Examples of suitable processes to print these inks are (amongst others): screen printing Xerography, photolithography (including directly photo-patternable materials), electrostatic deposition, spraying, ink jet printing and offset lithography. If patterning is not required, techniques such as wire roll coating (K-coaters) or blade coating may also be used.

Devices that embody the invention may be made in all sizes, large and small. This applies especially to displays, which may range from a single pixel device to a multi-pixel device, from miniature to macro-size displays.

The above-described and illustrated embodiments of the invention disclose various means for reducing cell-wall charge. That is, as compared to a conventional emitter cell of substantially constant diameter, formed in a conventional dielectric, cell-wall charging is reduced. Conventionally, a designer would attempt to provide as high a dielectric strength as possible. However, this leads to the problem illustrated in FIG. 3, that charges will tend to build up until they are dissipated with damaging results.

In constructing embodiments of the invention, a designer has a wide choice of parameter values, such as relative layer thicknesses and dielectric constants, for example, to achieve optimisation and limit cell-wall charging, thereby to achieve stable operation of the emitter cells. The figures of the accompanying drawings are diagrammatic and relative dimensions may vary from those shown. However, a device with relative dimensions along the lines as illustrated may be satisfactory.

In this specification, the verb “comprise” has its normal dictionary meaning, to denote non-exclusive inclusion. That is, use of the word “comprise” (or any of its derivatives) to include one feature or more, does not exclude the possibility of also including further features.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a genetic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A broad area field electron emitter comprising a plurality of emitter cells formed in a layered structure, each cell comprising a hole at the base of which a field electron emission material is disposed:
wherein said layered structure comprises:
an emitter layer having a substrate provided with an electrically conductive surface and said field electron emission material disposed on said surface;
a gate electrode spaced from said emitter layer, and
dielectric material disposed between said emitter layer and said gate electrode:
and wherein:
a first region of dielectric material contacts said emitter layer;
a second region of dielectric material contacts said gate electrode; and
means is provided for reducing cell-wall charge between said first and second regions.

2. A broad area field electron emitter according to claim 1, wherein said means for reducing cell-wall charge comprises an increase in the diameter of each cell from said first region to said second region.

3. A broad area field electron emitter according to claim 2, wherein the side walls of each cell taper linearly from said first region to said second region.

4. A broad area field electron emitter according to claim 2, wherein the side walls of each cell taper in a curved shape from said first region to said second region.

5. A broad area field electron emitter according to any of the preceding claims, wherein said means for reducing cell-wall charge comprises a current-leakage path provided within said dielectric material.

6. A broad area field electron emitter according to claim 5, wherein said dielectric material or further material is selected from the group comprising chromium sesquioxide and silica with low concentrations of carbon or iron oxide.

7. A broad area field electron emitter according to any of the preceding claims, wherein said means for reducing cell-wall charge comprises a low secondary electron yield material with first cross-over potential less than the maximum emitter layer to gate voltage of the emitter, said low secondary electron yield material comprising said dielectric material or an insulator material provided on the side walls of each cell.

8. A broad area field electron emitter according to claim 7, wherein said dielectric material or further material is selected from the group comprising Cr₂O₃, SiN, a-Si SiC, carbon and implanted carbon.

9. A broad area field electron emitter according to any of the preceding claims, wherein said means for reducing cell-wall charge comprises a layered configuration within said dielectric material to provide focusing of electrons emitted by said field electron emission material.

10. A broad area field electron emitter according to claim 9, wherein said layered configuration comprises a thin focus electrode between layers of said dielectric material.

11. A broad area field electron emitter according to claim 10, wherein said thin focus electrode is of metal.

12. A broad area field electron emitter according to claim 11, wherein said metal comprises chromium.

13. A broad area field electron emitter according to claim 10, 11 or 12, wherein said thin focus electrode has a thickness of less than 1 micron.

14. A broad area field electron emitter according to claim 9, wherein said layered configuration comprises layers of dielectric material of differing dielectric constant.

15. A broad area field electron emitter according to claim 14, wherein said layers of dielectric material of differing dielectric constant comprise a layer of lower dielectric constant which has a thickness in the range 10% to 80% of the thickness of the layered configuration of said dielectric material.

16. A broad area field electron emitter according to claim 14 or 15, wherein said layers of dielectric material have dielectric constants that differ in a ratio of at least 3:2.

17. A broad area field electron emitter according to claim 16, wherein said layers of dielectric material have dielectric constants that differ in a ratio of at least 4:1.

18. A broad area field electron emitter according to any of the preceding claims, wherein said dielectric material includes a layer of material that is porous relative to the rest of the dielectric material, to trap electrons.

19. A broad area field electron emitter according to claim 18, wherein said porous material has a porosity of approximately 50%.

20. A broad area field electron emitter substantially as hereinbefore described with reference to the accompanying drawings.

21. A field electron emission device comprising a broad area field electron emitter according to any of the preceding claims, and means for subjecting said emitter to an electric field in order to cause said emitter to emit electrons.

22. A field electron emission device according to claim 21, comprising a substrate with an array of patches of said broad area field electron emitter.

23. A field electron emission device according to claim 21 or 22, comprising a plasma reactor, corona discharge device, silent discharge device, ozoniser, an electron source, electron gun, electron device, x-ray tube, vacuum gauge, gas filled device or ion thruster.

24. A field electron emission device according to claim 21, 22 or 23, wherein the broad area field electron emitter supplies the total current for operation of the device.

25. A field electron emission device according to claim 21, 22, 23 or 24, wherein the broad area field electron emitter supplies a starting, triggering or priming current for the device.

26. A field electron emission device according to any of claims 21 to 25, comprising a display device.

27. A field electron emission device according to any of claims 21 to 25, comprising a lamp.

28. A field electron emission device according to clam 27, wherein said lamp is substantially flat.

29. A field electron emission device according to any of claims 21 to 28, wherein said broad area field electron emitter is connected to an electric driving means via a ballast resistor to limit current.

30. A field electron emission device according to claims 22 and 29, wherein said ballast resistor is applied as a resistive pad under each said emitting patch or in the form of a laterally conducting layer to segments of the emitting region.

31. A field electron emission device according to any of claims 21 to 30, wherein said broad area field electron emitter and/or a phosphor are coated upon one or more one-dimensional array of conductive tracks which are arranged to be addressed by electronic driving means so as to produce a scanning illuminated line.

32. A field electron emission device according to claim 31, including said electronic driving means.

33. A field electron emission device according to any of claims 21 to 32, wherein said broad area field electron emitter is disposed in an environment which is gaseous, liquid, solid, or a vacuum.

34. A field electron emission device according to any of claims 21 to 33, comprising a cathode which is optically translucent and is so in relation to an anode that electrons emitted from the cathode impinge upon the anode to cause electro-luminescence at the anode, which electro-luminescence is visible through the optically translucent cathode.

35. A field electron emission device substantially as hereinbefore described with reference to the accompanying drawings.
